(19) United States
(12) Patent Application Publication
(10) Pub. No.: US 2004/0058796 A1
(43) Pub. Date: Mar. 25, 2004

(54) Solid bowl centrifuge for separating mixtures of liquids and solids

(76) Inventors: Bernward Feldkamp, Wesel-Buderich (DE); Reinhold Schlip, Worthsee (DE); Ralf Mueller, Koln (DE); Manfred Seifert, Koln (DE)

Correspondence Address: Coleman Sudol Sapone, 714 Colorado Avenue, Bridgeport, CT, 06605-1601, US

(21) Appl. No.: 10/275,369

(22) PCT Filed: May 7, 2001
(86) PCT No.: PCT/EP01/05160

(30) Foreign Application Priority Data
May 5, 2000 (DE) 100 21 983.7

(51) Int. Cl. B04B 11/00; B04B 1/20

(52) U.S. Cl. 494/56; 494/53

(57) ABSTRACT

In order to separate solid-liquid mixtures in a solid bowl centrifuge containing a simply designed, adjustable weir for draining the liquid which makes it possible to control or adjust the level of the liquid in the centrifuge basket (10) during the operation of the centrifuge with the least possible expenditure of energy, the invention proposes to realize the adjustable weir in the form of a stationary, i.e., non-rotating, annular cup (20) that is connected to the centrifuge housing (18) and covers the liquid drain openings (13) of the basket (10) from the outside at a certain distance, wherein the annular cup contains at least one through-opening on its circumference, the size of which can be varied, and where the liquid drains into the liquid collection chamber (15) of the centrifuge housing through the aforementioned through-opening.

The invention pertains to a solid bowl centrifuge for separating solid-liquid mixtures, with discharge openings for the thick matter which are arranged in the basket shell on one end region, with drain openings for the liquid which are arranged in the end wall on the other end region of the centrifuge basket, and with a weir that can be adjusted from outside of the centrifuge basket and that serves for adjusting or varying the level of the liquid in the centrifuge basket during the operation of the centrifuge.

Known solid bowl centrifuges of tis type are predominantly realized in the form of helical conveyor centrifuges, in which a transport screw for transporting solids rotates in the basket shell with a rotational speed that differs from that of the basket. During the operation of such a centrifuge, a ring of liquid is formed within the basket due to centrifugal force, with the inside diameter of said ring of liquid being defined by the radial arrangement of the liquid drain openings that are uniformly distributed around the circumference of the basket end wall or by the height of radially adjustable weir disks that can be adjusted in order to vary the level of the liquid or the depth of the pool of liquid in the centrifuge basket.

It was already proposed to control the weir for adjusting the level of the liquid in the centrifuge basket of solid bowl centrifuges by means of an adjusting device that is arranged outside of the basket during the operation of the centrifuge. For example, DE-A 39 21 327 discloses a weir that consists of elements such as flaps, slides, wedges, etc. These elements are arranged within the region of the centrate drain openings that are distributed around the circumference of the basket end wall, and they rotate together with the basket. The adjusting elements which rotate with the basket are functionally connected to the non-rotating adjusting device, e.g., an axially adjustable, central set collar, via mechanical connecting elements. The quantity of the centrate being drained or the drainage resistance for the centrate can be influenced and thus the level of the liquid in the centrifuge basket can be regulated by adjusting the corresponding position of this set collar during the operation of the centrifuge. However, such a weir system has not prevailed in solid bowl centrifuges.

DE-A 43 20 265 also discloses a solid bowl centrifuge with an adjustable weir for draining the liquid phase. In this case, a non-rotating throttle disk that can be axially displaced is arranged outside of the basket opposite to the drain openings for the liquid phase. The free cross section between the drain openings for the centrate, which rotate with the basket and the throttle disk that can be displaced in an axially parallel and plane-parallel fashion defines the drainage cross section for the liquid and consequently its level in the basket. Leaving aside the fact that the device for the axially parallel guidance and displacement of the non-rotating throttle disk arranged plane-parallel relative to the basket end wall is not arranged outside of the wet portion and the particle portion of the centrifuge, the throttle disk presses the liquid that is draining from the weir openings directly against the rotating basket end wall, i.e., the throttle disk exerts a deceleration effect upon the centrifuge basket—similar to an eddy current brake-which needs to be compensated for by increasing the driving power of the centrifuge.

The present invention is based on the objective of developing a solid bowl centrifuge with a simply designed weir for draining the liquid which can be variably adjusted and which makes it possible to control or regulate the level of the liquid in the centrifuge basket in an operationally reliable fashion and with the least possible expenditure of energy during the operation of the centrifuge.

According to the invention, this objective is attained with a centrifuge with the characteristics of claim 1. Advantageous embodiments of the invention are disclosed in the subordinate claims.

According to one characteristic of the invention, the centrate which no longer contains solids is not directly thrown into the centrifuge housing with a high speed after it emerges from the openings in the basket end wall or the weir, but rather the adjustable weir consists of a stationary, i.e., non-rotating annular cup that cannot be axially displaced, wherein this annular cup is connected to the centrifuge housing and covers the liquid drain openings of the basket from the outside at a certain distance. The centrate initially drains freely into this annular cup from the drain openings in the end wall of the basket. The liquid then drains with a comparatively slow circumferential speed from the annular cup into the liquid collection chamber of the centrifuge housing through at least one through-opening arranged on the annular circumference of the cup, with the size of this through-opening being variable by means of an adjusting device. A subsequent acceleration of the centrate on the outer side of the basket end wall which consumes a lot of energy does not occur in this case. The level of the liquid in the stationary, non-rotating annular cup defines the level of the liquid in the centrifuge basket.

According to another characteristic of the invention, the adjusting device for varying the level of the liquid in the annular cup, and consequently in the centrifuge basket, may consist of an annular diaphragm that is arranged concentric to the annular cup and by means of turning the diaphragm, the free cross section of the through-opening(s) in the annular cup can be covered to a greater or lesser degree. The annular diaphragm may also be arranged in such a way that by means of axial displacement it covers the free cross section of the through-opening(s) in the annular cup to a greater or lesser degree. However, the adjusting device may also consist of an adjusting drive that engages one edge region of the annular cup with a displacement bolt, wherein the opposite edge of the annular cup is linked to the centrifuge housing such that an adjustment of the displacement bolt positions the annular cup in an inclined position that deviates from the vertical position, and where the annular cup contains a drain slot that widens obliquely.

The invention and its additional characteristics and advantages are described in greater detail below with reference to the embodiments that are schematically illustrated in the figures. Shown are:

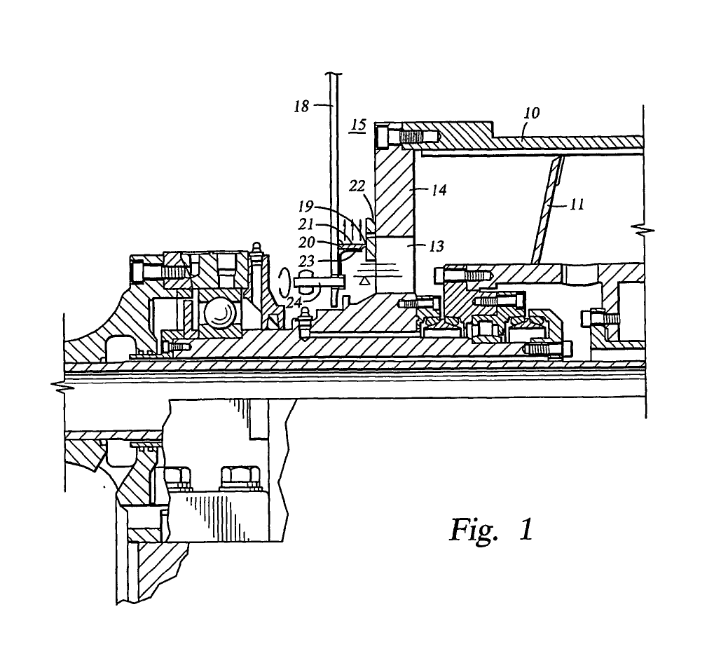

FIG. 1, part of a longitudinal section through a solid bowl centrifuge according to the invention with the adjustable weir for varying the level of the liquid in the centrifuge basket;

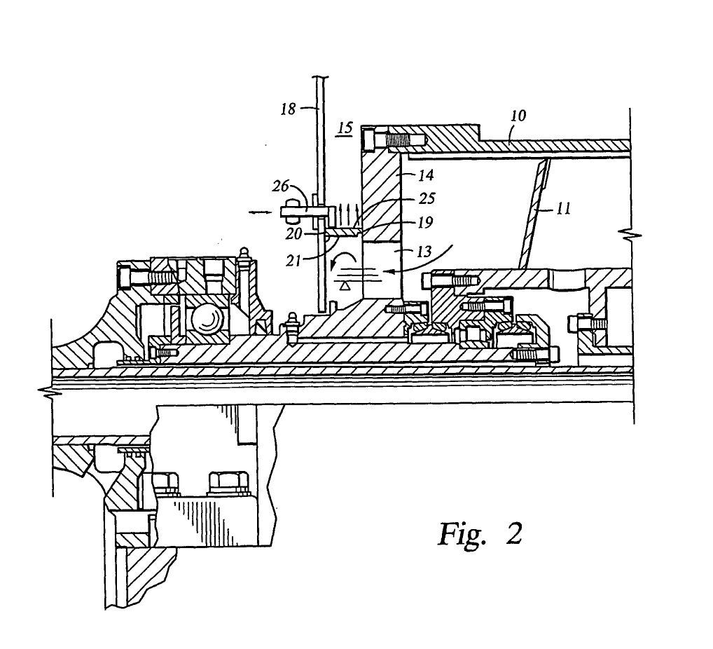

FIG. 2, part of the centrifuge according to FIG. 1 with another variation of the adjustable weir, and

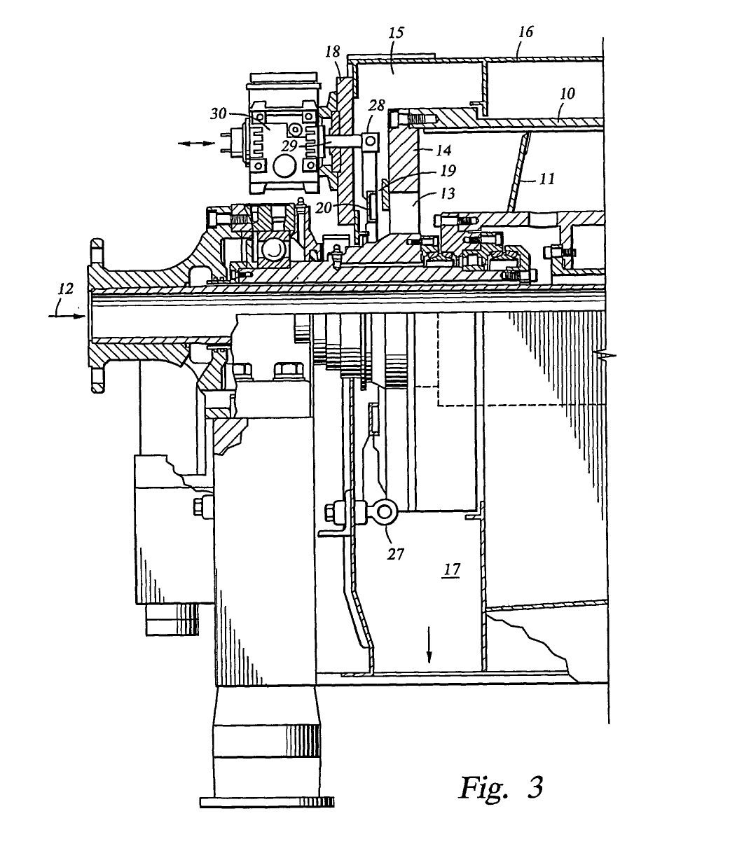

FIG. 3, part of a longitudinal section through such a centrifuge with another variation of the adjustable weir that contains an oblique annular gap or an oblique drain slot.

The helical conveyor centrifuge in all the figures contains a rotatable basket shell 10, in which a transport screw 11 is coaxially arranged in a rotatable fashion. This transport screw rotates in the same direction as the basket, but with a rotational speed that differs from that of the basket. The solid-liquid mixture 12 (FIG. 3) to be thickened or dewatered, e.g., sewage sludge, is introduced into the centrifuge basket 10 via the screw carrying body. During the operation of the helical conveyor centrifuge, a ring of liquid is formed within the basket 10 due to centrifugal force. In this case, the heavy solids which have sedimented on the basket wall are transported toward the right by means of the transport screw 11, lifted out of the suspension liquid by the not-shown right conical portion of the basket shell and transported to the not-shown discharge openings for solids or thick matter by the transport screw. The liquid (centrate) which no longer contains solids then drains from the centrifuge basket 10 through liquid drain openings 13 which are uniformly distributed around the circumference of the basket end wall 14 on the left end of the basket. The centrate emerging from the openings 13 is collected in a collection chamber 15 of the centrifuge housing 16 and diverted downward at this location by means of a chute 17.

The adjustable weir for draining the centrate consists of a stationary, i.e., non-rotating, annular cup 20 that is connected to the left side wall 18 of the centrifuge housing and covers the liquid drain openings 13 of the centrifuge basket 10 from the outside at a certain distance 19. This annular cup contains at least one through-opening 19 or 21, the size of which can bc varied by means of an adjusting device, on its annular circumference. The centrate drains into the collection chamber 15 through the at least one through-opening. The diameter of the non-rotating annular cup 20 approximately corresponds to the diameter of the circle that encloses all centrate drain openings 13 in the centrifuge basket 10. FIG. 1 indicates that the centrate drain openings 13 may also be equipped with weir disks 22 on their outer periphery.

The adjusting device for the controllable weir which is shown in FIG. 1 consists of an annular diaphragm 23 that is arranged concentric to the annular cup 20 and covers the free cross section of the through-opening(s) 21 in the annular cup 20 to a greater or lesser degree when it is turned by means of the element 24. In the embodiment according to FIG. 2, the adjusting device consists of an annular diaphragm 25 that is arranged concentric to the annular cup 20 and covers the free cross section of the through-opening(s) 21 in the annular cup 20 to a greater or lesser degree when it is axially displaced by means of the element 26. The annular cup 20 and the diaphragm 23 or 25 are mounted on the centrifuge housing wall 18. The adjusting element 24 or 26 may, for example, be actuated by a hydraulic cylinder, a pneumatic cylinder, a motor operator, a threaded bushing, etc.

According to FIG. 3, the annular cup 20 can be tilted or inclined into a position that deviates from the vertical position due to the fact that the annular cup 20 is coupled to at least one link 27 on one edge region, e.g., on the lower edge region, with a displacement bolt 29 that can be axially displaced by an adjusting drive 30 engaging the opposite edge region via an additional link 28. Due to these measures, the annular cup 20 can be inclined such that a correspondingly inclined, widening annular gap or drain slot 19 is formed. The centrate drains from the annular cup 20 into the collection chamber 15 of the centrifuge housing with a significantly reduced circumferential speed The throughput capacity of the widening drain slot 19 on the entire slot circumference is greater than that of a few individual weir openings. It is advantageous for the inclined centrate drain slot 19 to widen downward in the direction toward the centrate drain chute because this realizes simultaneously a self-cleaning of the drain slot 19, i.e., the risk of clogging the drain slot with solids that might still be contained in the centrate is minimized.

In addition, the deceleration effect exerted upon the basket end wall 14 by the annular cup 20 as well as the material wear are minimized in the adjustable weir according to the invention.

According to another characteristic of the invention, the adjusting element for automatically controlling the weir, i.e., for adjusting the effective width of the drain slot 19 or 21 assigned to the annular cup 20, may be connected to sensors for measuring the quantity and/or the TS [Dry substance] content and/or the viscosity of the thickened solids and/or the quantity/concentration of the sludge being introduced and/or the turbidity of the centrate being drained. Due to this measure, it is, for example, possible to automatically regulate, e.g., maintain a constant value, the dry substance content TS of the thick matter being discharged from the centrifuge by adjusting the level of the liquid in the centrifuge basket 10. In this case, a larger through-opening of the drain slot in the annular cup 20 results in a lower level of the liquid as well as a higher TS content of the thick matter being discharged and vice versa. The differential rotational speed between the basket 10 and the transport screw 11 does not have to be changed for this purpose, i.e., complicated differential rotary drives can be eliminated. In addition, the automatically adjustable weir according to the invention can be used for helical conveyor centrifuges with and without a baffle plate (negative/positive pool), and already installed centrifuges can be retrofitted with the automatically adjustable weir according to the invention.

1. Solid bowl centrifuge for separating solid-liquid mixtures, with discharge openings for the thick matter which are arranged in the basket shell (10) on one end region, with drain openings (13) for the liquid which are arranged in the end wall (14) on the other end region of the centrifuge basket, and with a weir that can be adjusted from outside of the centrifuge basket and that serves for adjusting or varying the level of the liquid in the centrifuge basket (10) during the operation of the centrifuge, characterized by the fact that the adjustable weir consists of a stationary, i.e., non-rotating, annular cup (20) that is connected to the centrifuge housing (18) and covers the liquid drain openings (13) of the centrifuge basket (10) from the outside at a certain distance, wherein the annular cap contains at least one through-opening, the size of which can be varied by means of an adjusting device (24, 26, 30), on its annular circumference, and where the liquid drains into the liquid collection chamber (15) of the centrifuge housing through the aforementioned through-opening.

2. Centrifuge according to claim 1, characterized by the fact that the diameter of the stationary annular cup (20) approximately corresponds to the diameter of a circle that encloses all liquid drain openings (13) of the centrifuge basket (10), and by the fact that a free annular gap (19) is formed between the free end surface of the annular cup and the adjacent end wall of the basket.

3. Centrifuge according to claim 1 or 2, characterized by the fact that the at least one through-opening (19) for the liquid which is arranged on the stationarily annular cup (20) consists of an oblique annular slot or drain slot that, in particular, widens toward the bottom.

4. Centrifuge according to claim 1, characterized by the fact that the adjusting device consists of a diaphragm (23) that is arranged concentric to the annular cup (20) and covers the free cross section of the through-opening(s) (21) of the annular cup (20) to a greater or lesser degree when it is turned.

5. Centrifuge according to claim 1, characterized by the fact that the adjusting device consists of a diaphragm (25) that is arranged concentric to the annular cup (20) and covers the free cross section of the through-opening(s) (21) of the annular cup (20) to a greater or lesser degree when it is axially displaced.

6. Centrifuge according to claims 1-5, characterized by the fact that the annular cup (20) as well as the diaphragm (23, 25) of the adjusting device are mounted on the centrifuge housing wall (18) that is situated adjacent to the basket end wall (14) with the liquid drain openings (13).

7. Centrifuge according to claim 6, characterized by the fact that an adjusting element (24, 26) is arranged outside of the centrifuge housing wall (18), with the adjusting element being functionally connected to the diaphragm (23, 25) that can be adjusted inside of the housing wall.

8. Centrifuge according to claim 7, characterized by the fact that the adjusting element (24, 26) contains-a motor operator (30), a hydraulic cylinder, a pneumatic cylinder, a threaded bushing, etc.

9. Centrifuge according to claim 8, characterized by the fact that the adjusting element for automatically adjusting the weir, i.e., for adjusting the effective width of the drain slot (19 or 21) assigned to the annular cup (20), is connected to sensors for measuring the quantity and/or TS content and/or the viscosity of the thickened solids being discharged and/or the quantity/concentration of the sludge being introduced and/or the turbidity of the centrate being drained.
